(19) United States
(12) Patent Application Publication
(10) Pub. No.: US 2026/0371132 A1
(43) Pub. Date: Nov. 19, 2026

(54) METHOD AND DEVICE FOR TRANSMITTING ALTITUDE EVENT-BASED MEASUREMENT RESULT INFORMATION IN WIRELESS COMMUNICATION SYSTEM

(71) Applicant: Samsung Electronics Co., Ltd., Suwon-si, Gyeonggi-do (KR)

(72) Inventor: Sangyeob JUNG, Suwon-si (KR)

(21) Appl. No.: 19/470,743

(22) PCT Filed: Mar. 25, 2024
(86) PCT No.: PCT/KR2024/003669

§ 371 Date: Sep. 29, 2025

(30) Foreign Application Priority Data
Mar. 29, 2023 (KR) 10-2023-0041267

(51) Int. Cl. H04W 24/10; H04B 17/318; H04W 8/24; H04W 84/06

(52) U.S. Cl. CPC H04W 24/10; H04B 17/328; H04W 8/24; H04W 84/06

(57) ABSTRACT

The present disclosure relates to a 5G communication system or a 6G communication system for supporting higher data rates beyond a 4G communication system such as long term evolution (LTE). This method performed by a terminal of a wireless communication system comprises the steps of: transmitting information about capabilities of the terminal to a base station; receiving configuration information for measurement reporting from the base station; and transmitting the measurement report to the base station on the basis of the configuration information.

### TECHNICAL FIELD

The disclosure relates to communications, and relates to operation of a user equipment (UE) and a base station. Specifically, the disclosure relates to a method of transmitting height event-based measurement result information, and a UE, base station, and communication system related thereto.

### BACKGROUND ART

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 psec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time, a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive eXtended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

Embodiments set forth herein are to provide a device and a method capable of effectively providing services in a wireless communication system.

### Solution to Problem

A method according to an embodiment of the disclosure, an operation method of a user equipment (UE) in a wireless communication system may include an operation of receiving measurement configuration information based on UE capability information from a base station, an operation of performing measurement based on measurement configuration information, an operation of identifying whether measurement reporting for any one of event H1 or event H2 is triggered after performing the measurement, and an operation of performing measurement reporting triggered based on a result of the identification.

### Advantageous Effects of Invention

The disclosure can provide a device and a method capable of effectively providing services in a wireless communication system.

### BRIEF DESCRIPTION OF DRAWINGS

FIG. 1A illustrates a structure of an LTE system according to an embodiment of the disclosure.

FIG. 1B illustrates a radio protocol structure in an LTE system according to an embodiment of the disclosure.

FIG. 1C illustrates a structure of a next-generation mobile communication system according to an embodiment of the disclosure.

FIG. 1D illustrates a radio protocol structure of a next-generation mobile communication system according to an embodiment of the disclosure.

FIG. 1E is a flowchart illustrating a process in which an uncrewed aerial vehicle (UAV) user equipment (UE) transmits a height event-based measurement result message to a base station in a next generation mobile communication system according to an embodiment of the disclosure.

FIG. 1F is a flowchart illustrating a process in which an uncrewed aerial vehicle (UAV) user equipment (UE) transmits a height event-based measurement result message to a base station in a next generation mobile communication system according to an embodiment of the disclosure.

FIG. 1G is a flowchart illustrating a process in which an uncrewed aerial vehicle (UAV) user equipment (UE) transmits a height event-based measurement result message to a base station in a next generation mobile communication system according to an embodiment of the disclosure.

FIG. 1H is a flowchart illustrating a process in which an uncrewed aerial vehicle (UAV) user equipment (UE) transmits a height event-based measurement result message to a base station in a next generation mobile communication system according to an embodiment of the disclosure.

FIG. 1I is a flowchart illustrating a process in which an uncrewed aerial vehicle (UAV) user equipment (UE) transmits a height event-based measurement result message to a base station in a next generation mobile communication system according to an embodiment of the disclosure.

FIG. 1J is a flowchart illustrating a process in which an uncrewed aerial vehicle (UAV) user equipment (UE) transmits a height event-based measurement result message to a base station in a next generation mobile communication system according to an embodiment of the disclosure.

FIG. 1K is a flowchart illustrating a process in which an uncrewed aerial vehicle (UAV) user equipment (UE) transmits a height event-based measurement result message to a base station in a next generation mobile communication system according to an embodiment of the disclosure.

FIG. 1L illustrates an internal structure of a UE according to an embodiment of the disclosure.

FIG. 1M illustrates a structure of an NR base station according to an embodiment of the disclosure.

### MODE FOR THE INVENTION

Hereinafter, the operation principle of the disclosure will be described in detail with reference to the accompanying drawings. In describing the disclosure below, a detailed description of known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs may designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors. In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in in the 3rd generation partnership project long term evolution (3GPP LTE) standards may be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”.

In the following description of the disclosure, terms and names defined in in the 3rd generation partnership project long term evolution (3GPP LTE) standards may be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, abase station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS, eNode B, or gNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. Therefore, for the services supporting URLLC, a 5G system must provide a transmit time interval (TTI) shorter than those of other services, and also may require a design for assigning a large number of resources in a frequency band in order to secure reliability of a communication link.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

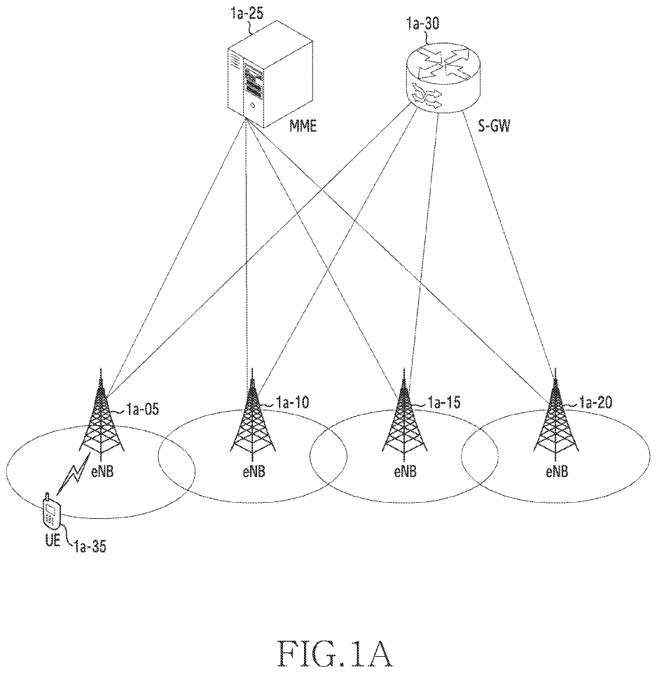

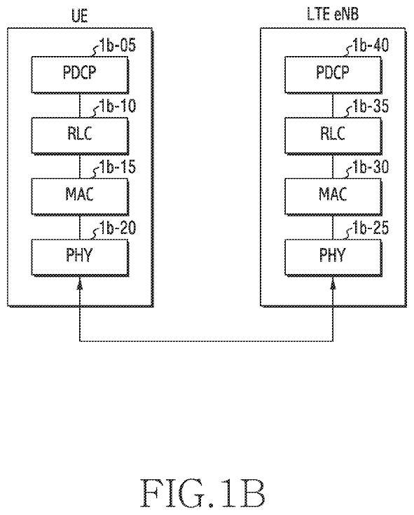

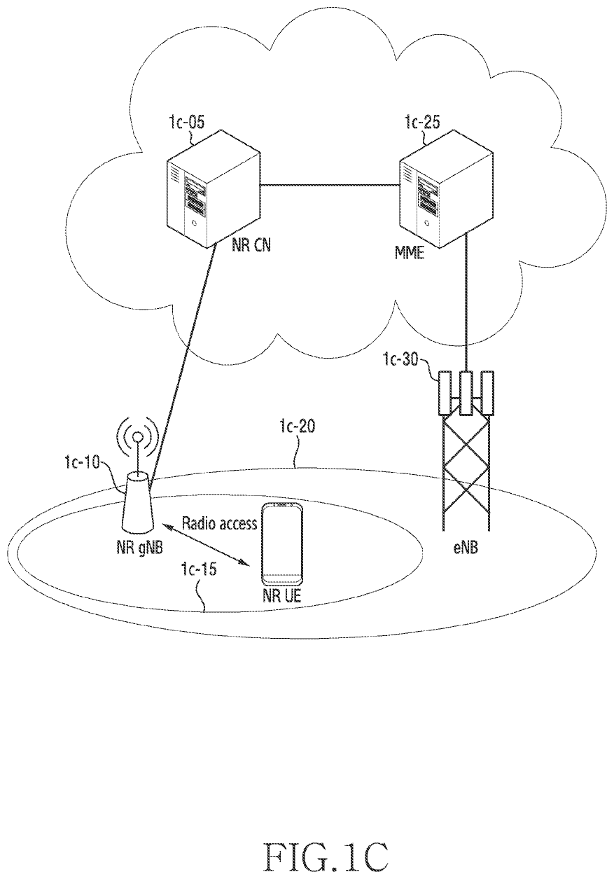

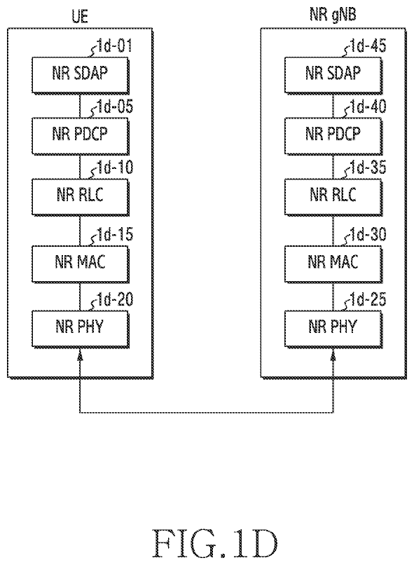

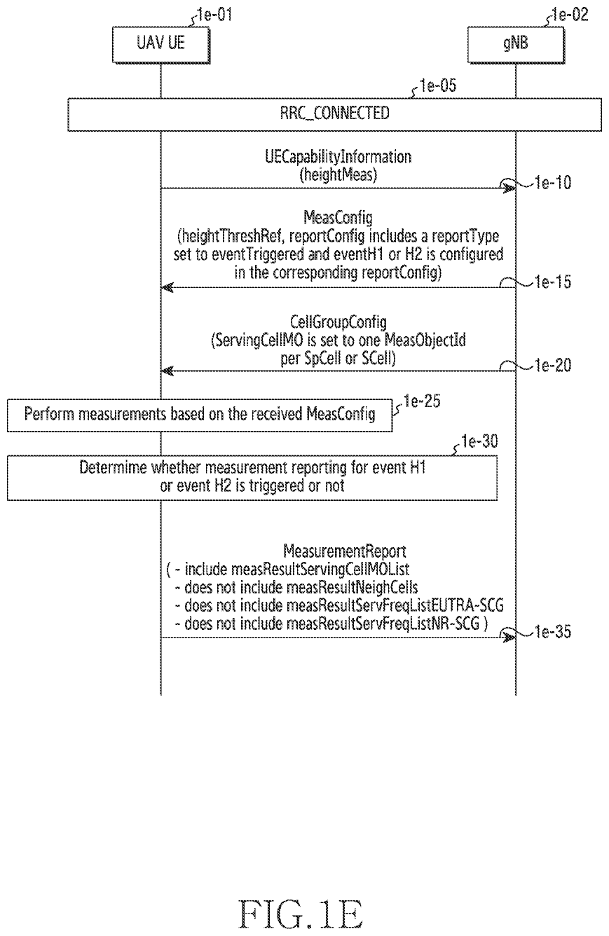

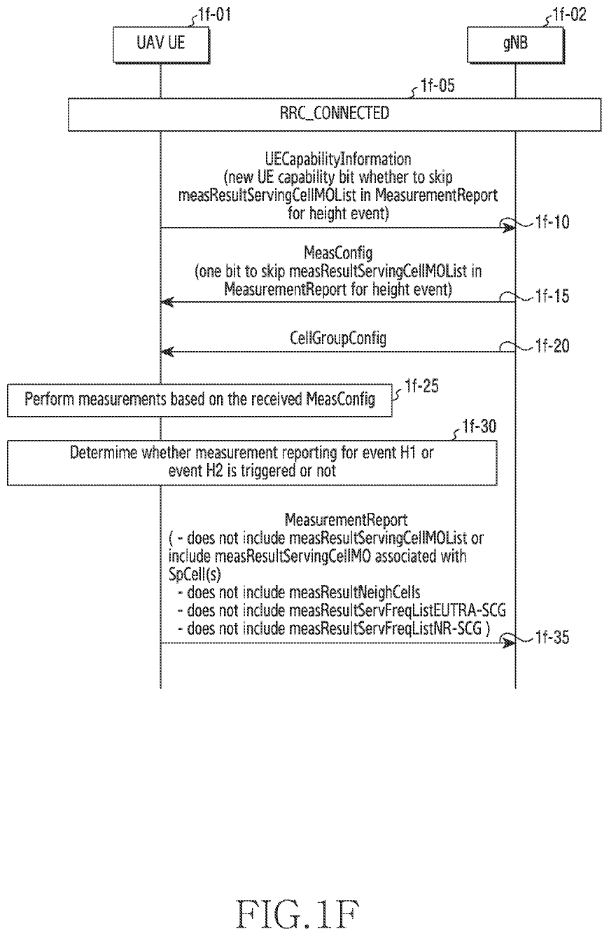

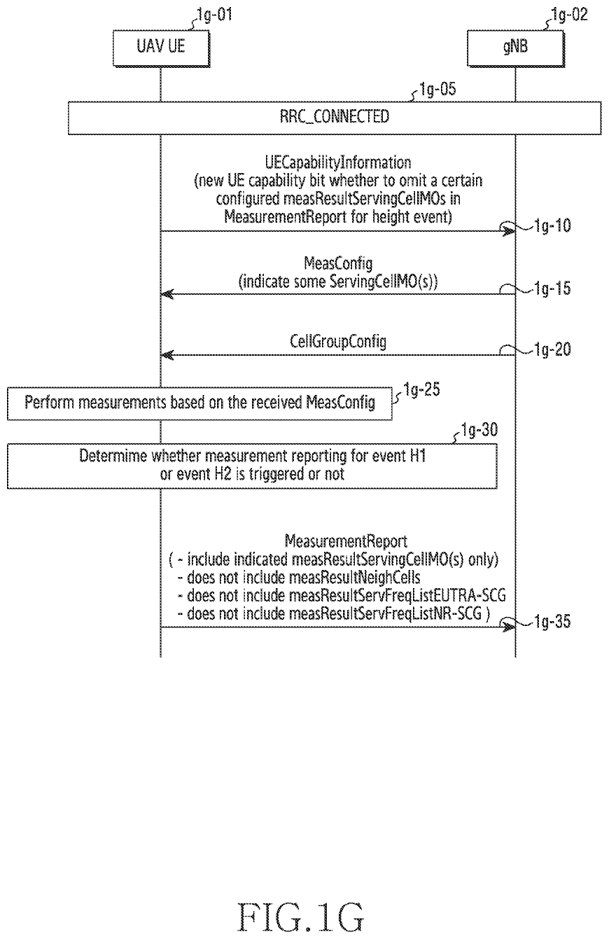

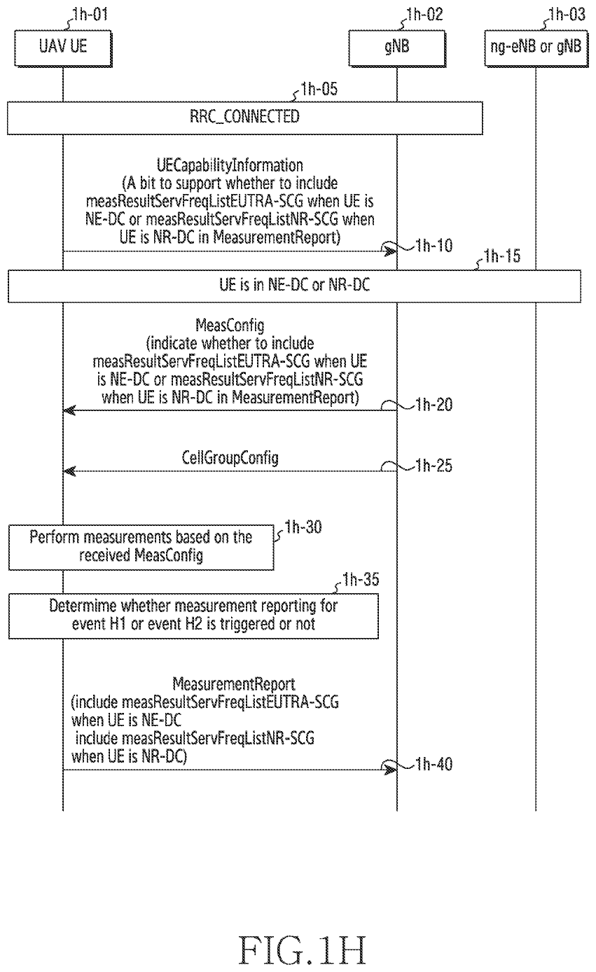

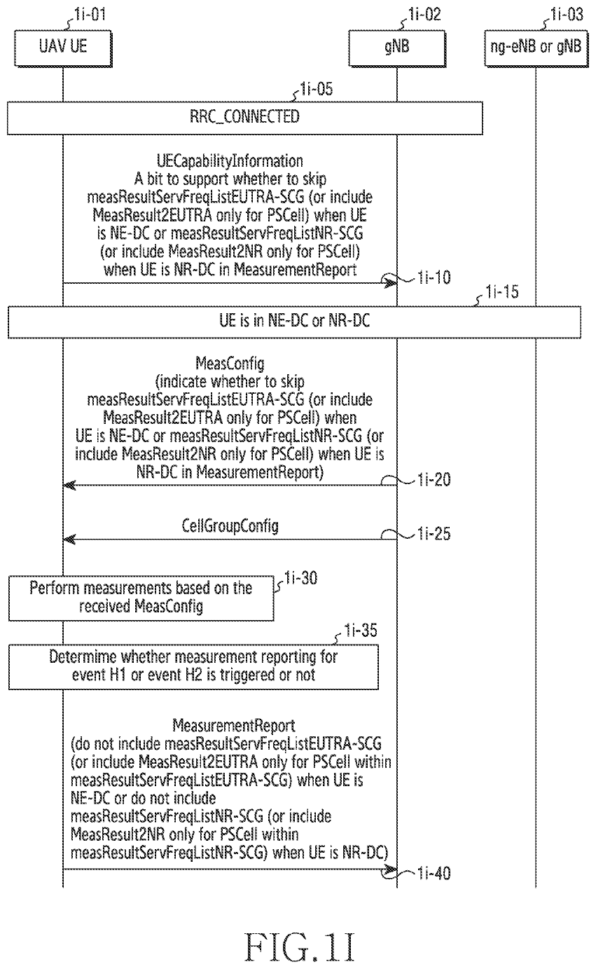

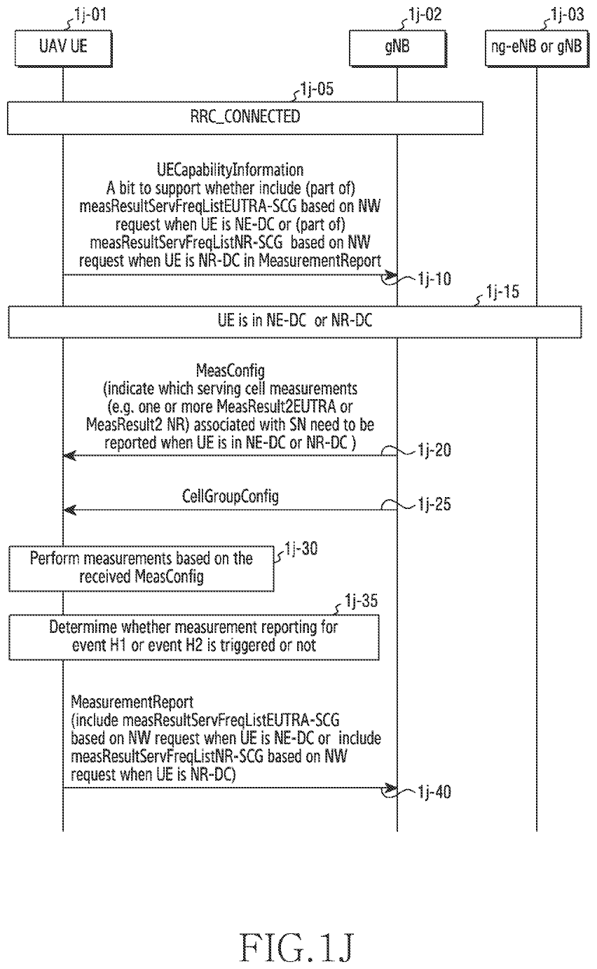

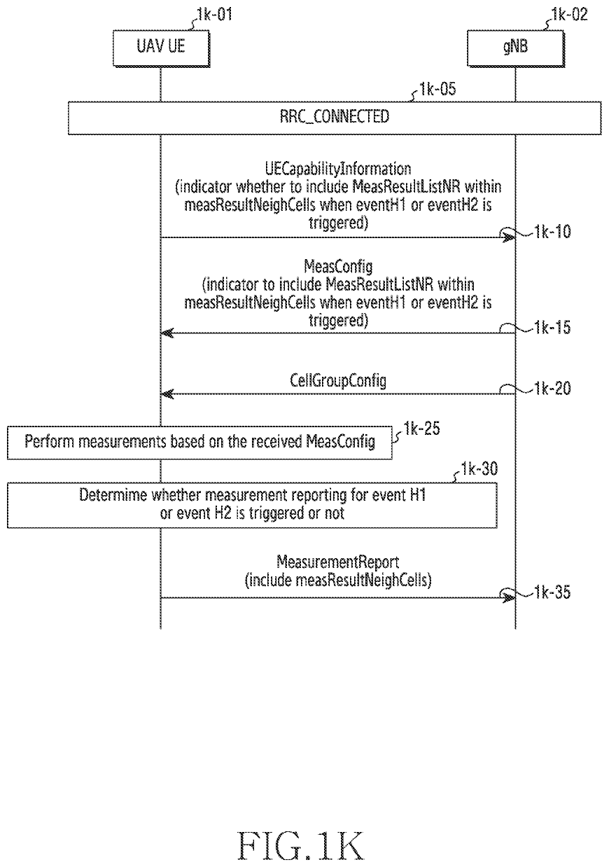

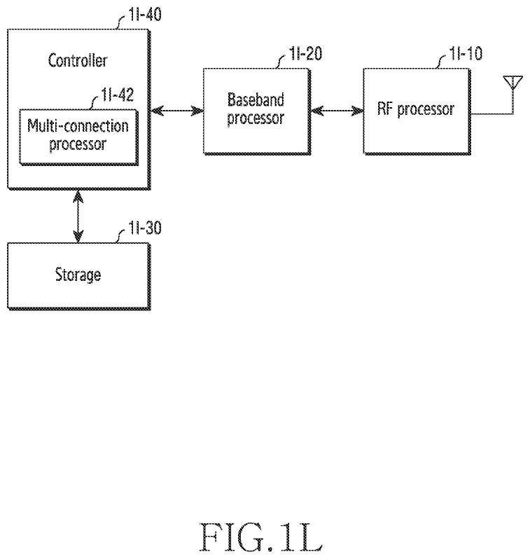

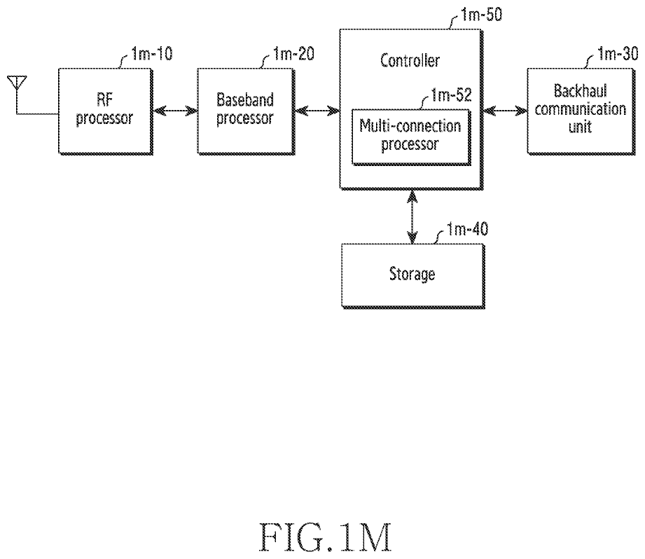

FIG. 1A illustrates a structure of an LTE system according to an embodiment of the disclosure.

Referring to FIG. 1A, as illustrated therein, a radio access network of an LTE system may include next-generation base stations (evolved node Bs, hereinafter ENBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 may access an external network through the ENBs 1a-05 to 1a-20 and the S-GW 1a-30.

In FIG. 1A, the ENBs 1a-05 to 1a-20 may correspond to conventional Node Bs of a universal mobile telecommunication system (UMTS). The ENBs may be connected to the UE 1a-35 through a radio channel, and perform more complicated roles than the conventional node Bs. In the LTE system, since all user traffic including real-time services, such as voice over IP (VoIP) via the Internet protocol, is serviced through a shared channel, a device that collects state information, such as buffer states, available transmit power states, and channel states of UEs, and performs scheduling accordingly is required, and the ENBs 1a-05 to 1a-20 serve as the device. In general, one ENB may control multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Obviously, the above example is not limiting. Furthermore, the ENBs 1a-05 to 1a-20 may employ an adaptive modulation & coding (hereinafter referred to as AMC) scheme for determining a modulation scheme and a channel coding rate according to a channel state of a UE. The S-GW 1a-30 is a device that provides a data bearer, and may generate or remove a data bearer under the control of the MME 1a-25. The MME is a device responsible for various control functions as well as a mobility management function for a UE, and is connected to multiple base stations.

FIG. 1B illustrates a radio protocol structure in an LTE system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, and a medium access control (MAC) 1b-15 or 1b-30 on each of UE and ENB sides. The packet data convergence protocol (PDCP) 1b-05 or 1b-40 is responsible for operations such as IP header compression/reconstruction. The main functions of the PDCP may be summarized as follows. Obviously, the examples given below are not limiting.
Header compression and decompression: robust header compression (ROHC) only
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 1b-10 or 1b-35 may reconfigure a PDCP protocol data unit (PDU) into an appropriate size to perform an ARQ operation. The main functions of the RLC may be summarized as follows. Obviously, the examples given below are not limiting.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 may be connected to several RLC layer devices configured in a single terminal, and multiplex RLC PDUs into an MAC PDU and demultiplex RLC PDUs from an MAC PDU. The main functions of the MAC are summarized as follows. Obviously, the examples given below are not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer 1b-20 or 1b-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the examples given below are not limiting.

FIG. 1C illustrates a structure of a next-generation mobile communication system according to an embodiment of the disclosure.

Referring to FIG. 1C, as illustrated therein, a radio access network of a wireless communication system (hereinafter next-generation mobile (or wireless) communication system, NR, or 5G) may include a new radio Node B (hereinafter NR gNB or NR base station) 1c-10, and a new radio core network (NR CN) 1c-05. A user terminal (new radio user equipment, hereinafter NR UE or NR terminal) 1c-15 may access an external network via the NR gNB 1c-10 and the NR CN 1c-05.

In FIG. 1C, the NR gNB 1c-10 may correspond to an evolved Node B (eNB) of a conventional LTE system. The NR gNB is connected to the NR UE 1c-15 through a radio channel, and can provide outstanding services as compared to a conventional node Bs. In the next-generation mobile communication system, since all user traffic is serviced through a shared channel, a device that collects state information, such as buffer statuses, available transmit power states, and channel states of UEs, and performs scheduling accordingly is required, and the NR gNB 1c-10 may serve as the device. In general, one NR gNB may control multiple cells.

According to an embodiment of the disclosure, in order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, according to an embodiment of the disclosure, the NR gNB 1c-10 may employ an adaptive modulation & coding (hereinafter referred to as AMC) scheme for determining a modulation scheme and a channel coding rate according to a channel state of a UE. The NR CN 1c-05 may perform functions such as mobility support, bearer configuration, and QoS configuration. The NR CN 3-05 is a device responsible for various control functions as well as a mobility management function for a UE, and may be connected to multiple base stations. In addition, the next-generation mobile communication system may interwork with the existing LTE system, and the NR CN may be connected to an MME 1c-25 via a network interface. The MME may be connected to an eNB 1c-30 that is an existing base station.

FIG. 1D illustrates a radio protocol structure of a next-generation mobile communication system according to an embodiment of the disclosure.

FIG. 1D illustrates a radio protocol structure of a next-generation mobile communication system to which the disclosure is applicable.

Referring to FIG. 1D, a radio protocol of a next-generation mobile communication system may include an NR service data adaptation protocol (SDAP) 1d-01 or 1d-45, an NR packet data convergence protocol (PDCP) 1d-05 or 1d-40, an NR radio link control (RLC) 1d-10 or 1d-35, and an NR medium access controls (MAC) 1d-15 or 1d-30 on each of UE and NR base station sides.

According to an embodiment of the disclosure, the main functions of the NR SDAP 1d-01 or 1d-45 may include some of functions below. Obviously, the examples given below are not limiting.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

According to an embodiment of the disclosure, the main functions of the NR PDCP 1d-05 or 1d-40 may include some of functions below. Obviously, the examples given below are not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

According to an embodiment of the disclosure, the reordering of the NR PDCP device refers to a function of reordering PDCP PDU received from a lower layer in an order based on PDCP sequence numbers (SNs), and may include at least one of a function of transferring data to an upper layer according to a rearranged order, a function of directly transferring data without considering order, a function of rearranging order to record lost PDCP PDUs, a function of reporting the state of lost PDCP PDUs to a transmission side, or a function of requesting retransmission of lost PDCP PDUs.

According to an embodiment of the disclosure, the main functions of the NR RLC 1d-10 or 1d-35 may include some of functions below. Obviously, the examples given below are not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

According to an embodiment of the disclosure, the in-sequence delivery of the NR RLC device may refer to a function of, if there is a lost RLC PDU, delivering only RLC SDUs before the lost RLC PDU to the upper layer in sequence. The in-sequence delivery may include at least one of a function of, if one original RLC SDU is divided into several RLC SDUs and then the RLC SDUs are received, reassembling the several RLC SDUs and transferring the reassembled RLC SDUs, a function of rearranging received RLC PDUs with reference to RLC sequence numbers (SNs) or PDCP sequence numbers (SNs), a function of rearranging order to record lost RLC PDUs, a function of reporting the state of lost RLC PDUs to a transmission side, a function of requesting retransmission of lost RLC PDUs, a function of, if there is a lost RLC SDU, sequentially transferring only RLC SDUs before the lost RLC SDU to an upper layer, a function of, although there is a lost RLC SDU, if a predetermined timer has expired, sequentially transferring, to an upper layer, all the RLC SDUs received before the timer is started, and a function of, although there is a lost RLC SDU, if a predetermined timer has expired, sequentially transferring all the RLC SDUs received up to the current, to an upper layer.

In addition, according to an embodiment of the disclosure, the NR RLC 1d-10 or 1d-35 may process RLC PDUs in the received order (regardless of the sequence number order, in the order of arrival) and deliver same to the PDCP device regardless of the order (out-of-sequence delivery), and in the case of segments, may receive segments which are stored in a buffer or which are to be received later, reconfigure same into one complete RLC PDU, process and deliver same to the PDCP device. The NR RLC 1d-10 or 1d-35 may include no concatenation function, which may be performed in the NR MAC layer or replaced with a multiplexing function of the NR MAC layer. Obviously, the above example is not limiting.

The out-of-sequence delivery of the NR RLC device 1d-10 or 1d-35 may include a function of directly delivering RLC SDUs received from a lower layer to an upper layer regardless of the order, and may include at least one of a function of reassembling and delivering multiple RLC SDUs received, into which one original RLC SDU has been segmented, and a function of storing and reordering the RLC SNs or PDCP SNs of received RLC PDUs and recording lost RLC PDUs.

According to an embodiment of the disclosure, the NR MAC 1d-15 or 1d-30 may be connected to multiple NR RLC layer devices configured in one UE, and the main functions of the NR MAC may include at least some of functions below. Obviously, the examples given below are not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, an NR PHY layer 1d-20 or 1d-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the examples given below are not limiting.

FIG. 1E is a flowchart illustrating a process in which an uncrewed aerial vehicle (UAV) user equipment (UE) transmits a height event-based measurement result message to a base station in a next generation mobile communication system according to an embodiment of the disclosure.

The UAV UE is a UE that is capable of aviating. Therefore, the UAV UE may have a higher line of sight than that of a terrestrial UE. Therefore, the UAV UE may receive downlink (DL) interference from a larger number of cells as compared with the terrestrial UE. That is, the UAV UE has a feature of receiving a high level of DL interference from a larger number of neighboring cells as compared with the terrestrial UE. In the same manner, the UAV UE may cause uplink (UL) interference to a larger number of cells as compared with the terrestrial UE. The disclosure proposes a method of reporting MeasurementReport to a base station according to a characteristic of the UAV UE.

Referring to FIG. 1E, a UAV UE 1e-01 may be in an RRC connected mode (RRC_CONNECTED) by configuring an RRC connection with an NR base station 1e-02.

In operation 1e-10, the UE 1e-01 may transmit a UE capability information message (UECapabilityInformation) to the base station 1e-02. In the UE capability information message, an indicator (highMeas) indicating whether the UE 1e-01 supports event H1 or event H2 is included.

In operation 1e-15, the base station 1e-02 may transmit a predetermined RRC message (e.g., RRCReconfiguration) including measurement configuration information (MeasConfig) to the UE 1e-01. The measurement configuration information may include a reference height threshold value (heightThreshRef) of event H1 and event H2 of report configuration information (ReportConfigNR). The height threshold value may be one of integer values, and the one integer value may be a predetermined height. For example, value 0 may be −420 m. In this instance, the height may be configured based on a predetermined height. For example, a predetermined height value may be expressed based on a sea level. In this instance, the reference height threshold value may be expressed as a value indicating a predetermined range, as opposed to a single value. For example, value 0 may be a height value range of −420m to −410m. The measurement configuration information may include NR report configuration information (reportConfigNR) including an event H1 or event H2 triggering condition. According to an embodiment of the disclosure, reportType of ReportConfigNR may be set to eventTriggered, and in event H1 or event H2 may be newly defined in corresponding EventTriggerConfig, as shown below. In this instance, the base station 1e-02 may configure single or multiple ReportConfigNR for the UE 1e-01. However, this is not limited to the following example.

| ReportConfigNR ::= | | SEQUENCE { |
|---|---|---|
| reportType | | CHOICE { |
| | periodical | PeriodicalReportConfig, |
| | eventTriggered | EventTriggerConfig, |
| | ..., | |
| | reportCGI | ReportCGI, |
| | reportSFTD | ReportSFTD-NR, |
| | condTriggerConfig-r16 | CondTriggerConfig-r16, |
| | cli-Periodical-r16 | CLI-PeriodicalReportConfig-r16, |
| | cli-EventTriggered-r16 | CLI-EventTriggerConfig-r16, |
| | rxTxPeriodical-r17 | RxTxPeriodical-r17 |
| } | | |
| } | | |
| EventTriggerConfig::= | | SEQUENCE { |
| eventId | | CHOICE { |
| | eventA1 | SEQUENCE { |
| | a1-Threshold | MeasTriggerQuantity, |
| | reportOnLeave | BOOLEAN, |
| | hysteresis | Hysteresis, |
| | timeToTrigger | TimeToTrigger |
| | }, | |
| | eventA2 | SEQUENCE { |
| | a2-Threshold | MeasTriggerQuantity, |
| | reportOnLeave | BOOLEAN, |
| | hysteresis | Hysteresis, |
| | timeToTrigger | TimeToTrigger |
| | }, | |
| | eventA3 | SEQUENCE { |
| | a3-Offset | |
| MeasTriggerQuantityOffset, | | |
| | reportOnLeave | BOOLEAN, |
| | hysteresis | Hysteresis, |
| | timeToTrigger | TimeToTrigger, |
| | useAllowedCellList | BOOLEAN |
| | }, | |
| | eventA4 | SEQUENCE { |
| | a4-Threshold | MeasTriggerQuantity, |
| | reportOnLeave | BOOLEAN, |
| | hysteresis | Hysteresis, |
| | timeToTrigger | TimeToTrigger, |
| | useAllowedCellList | BOOLEAN |
| | }, | |
| | eventA5 | SEQUENCE { |
| | a5-Threshold1 | MeasTriggerQuantity, |
| | a5-Threshold2 | MeasTriggerQuantity, |
| | reportOnLeave | BOOLEAN, |
| | hysteresis | Hysteresis, |
| | timeToTrigger | TimeToTrigger, |
| | useAllowedCellList | BOOLEAN |
| | }, | |
| | eventA6 | SEQUENCE { |
| | a6-Offset | |
| MeasTriggerQuantityOffset, | | |
| | reportOnLeave | BOOLEAN, |
| | hysteresis | Hysteresis, |
| | timeToTrigger | TimeToTrigger, |
| | useAllowedCellList | BOOLEAN |
| | }, | |
| | ..., | |
| | [[ | |
| | eventX1-r17 | SEQUENCE { |
| | x1-Threshold1-Relay-r17 | SL-MeasTriggerQuantity-r16, |
| | x1-Threshold2-r17 | MeasTriggerQuantity, |
| | reportOnLeave-r17 | BOOLEAN, |
| | hysteresis-r17 | Hysteresis, |
| | timeToTrigger-r17 | TimeToTrigger, |
| | useAllowedCellList-r17 | BOOLEAN |
| | }, | |
| | eventX2-r17 | SEQUENCE { |
| | x2-Threshold-Relay-r17 | SL-MeasTriggerQuantity-r16, |
| | reportOnLeave-r17 | BOOLEAN, |
| | hysteresis-r17 | Hysteresis, |
| | timeToTrigger-r17 | TimeToTrigger |
| | }, | |
| | eventD1-r17 | SEQUENCE { |
| | distanceThreshFromReference1-r17 | INTEGER(1.. 65525), |
| | distanceThreshFromReference2-r17 | INTEGER(1.. 65525), |
| | referenceLocation1-r17 | ReferenceLocation-r17, |
| | referenceLocation2-17 | ReferenceLocation-r17, |
| | reportOnLeave-r17 | BOOLEAN, |
| | hysteresisLocation-r17 | HysteresisLocation-r17, |
| | timeToTrigger-r17 | TimeToTrigger |
| | } | |
| | ]], | |
| | [[ | |
| | eventH1-r18 | SEQUENCE { |
| | h1-ThresholdOffset-r18 | |
| INTEGER(0..300), | | |
| | h1-Hysteresis-r18 | INTEGER(1..16), |
| | timeToTrigger-r18 | |
| TimeToTrigger, | | |
| | useAllowedCellList-r18 | |
| | BOOLEAN, | |
| | reportOnLeave-r18 | |
| BOOLEAN | | |
| | }, | |
| | eventH2-r18 | SEQUENCE { |
| | h2-ThresholdOffset-r18 | |
| INTEGER(0..300), | | |
| | h2-Hysteresis-r18 | INTEGER(1..16), |

```
      timeToTrigger-r18
      TimeToTrigger,
          useAllowedCellList-r18
          BOOLEAN,
          reportOnLeave-r18
          BOOLEAN
      }
      ]]
```

| }, | |
|---|---|
| rsType | NR-RS-Type, |
| reportInterval | ReportInterval, |
| reportAmount | ENUMERATED {r1, r2, r4, r8, |
| r16, r32, r64, infinity}, | |
| reportQuantityCell | MeasReportQuantity, |
| maxReportCells | INTEGER (1..maxCellReport), |
| reportQuantity RS-Indexes | MeasReportQuantity |

| | |
|---|---|
| OPTIONAL, | -- Need R |

| maxNrofRS-IndexesToReport | | INTEGER |
|---|---|---|
| (1..maxNrofIndexesToReport) | OPTIONAL, -- Need R | |
| includeBeamMeasurements | BOOLEAN, | |
| reportAddNeighMeas | ENUMERATED {setup} | |

| | |
|---|---|
| OPTIONAL, | -- Need R |

| ..., | |
|---|---|
| [[ | |
| measRSSI-ReportConfig-r16 | MeasRSSI-ReportConfig-r16 |

| OPTIONAL, | -- Need R | |
|---|---|---|
| useT312-r16 | | BOOLEAN |
| OPTIONAL, | -- Need M | |

| | |
|---|---|
| includeCommonLocationInfo-r16 | ENUMERATED {true} |

| | |
|---|---|
| OPTIONAL, | -- Need R |

| | |
|---|---|
| includeBT-Meas-r16 | SetupRelease {BT-NameList-r16} |

| | |
|---|---|
| OPTIONAL, | -- Need M |

| | |
|---|---|
| includeWLAN-Meas-r16 | SetupRelease {WLAN- |

| | |
|---|---|
| NameList-r16} | OPTIONAL, -- Need M |

| | |
|---|---|
| includeSensor-Meas-r16 | SetupRelease {Sensor-NameList- |

| | |
|---|---|
| r16} | OPTIONAL -- Need M |

| ]], | |
|---|---|
| [[ | |
| coarseLocationRequest-r17 | ENUMERATED {true} |

| | |
|---|---|
| OPTIONAL, | -- Need R |

| | |
|---|---|
| reportQuantityRelay-r17 | SL-MeasReportQuantity-r16 |

| | |
|---|---|
| OPTIONAL | -- Need R |

```
      ]]
  }
```

According to an embodiment of the disclosure, predetermined configuration information included in event H1 or event H2 may include, for example, other integer number values. In this instance, the measurement configuration information may have the following ASN.1 structure, and the UE 1e-01 may apply measurement configuration information received from the base station 1e-02. However, this is not limited to the following example.

```
    -- ASN1START
  -- TAG-MEASCONFIG-START
```

| | |
|---|---|
| MeasConfig ::= | SEQUENCE { |

| | |
|---|---|
| measObjectToRemoveList | MeasObjectToRemoveList |

| | |
|---|---|
| OPTIONAL, | -- Need N |

| | |
|---|---|
| measObjectToAddModList | MeasObjectToAddModList |

| | |
|---|---|
| OPTIONAL, | -- Need N |

| | |
|---|---|
| reportConfigToRemoveList | ReportConfigToRemoveList |

| | |
|---|---|
| OPTIONAL, | -- Need N |

| | |
|---|---|
| reportConfigToAddModList | ReportConfigToAddModList |

| | |
|---|---|
| OPTIONAL, | -- Need N |

| | |
|---|---|
| measIdToRemoveList | MeasIdToRemoveList |

| | |
|---|---|
| OPTIONAL, | -- Need N |

| | |
|---|---|
| measIdToAddModList | MeasIdToAddModList |

| OPTIONAL, | -- Need N | |
|---|---|---|
| s-MeasureConfig | | CHOICE { |
| | ssb-RSRP | RSRP-Range, |
| | csi-RSRP | RSRP-Range |

}

| | |
|---|---|
| OPTIONAL, | -- Need M |

| | |
|---|---|
| quantityConfig | QuantityConfig |

| | |
|---|---|
| OPTIONAL, | -- Need M |

| | |
|---|---|
| measGapConfig | MeasGapConfig |

| | |
|---|---|
| OPTIONAL, | -- Need M |

| | |
|---|---|
| measGapSharingConfig | MeasGapSharingConfig |

| | |
|---|---|
| OPTIONAL, | -- Need M |

```
      ...,
      [[
```

| | |
|---|---|
| interFrequencyConfig-NoGap-r16 | ENUMERATED {true} |

| | |
|---|---|
| OPTIONAL | -- Need R |

```
      ]]
  }
```

| | |
|---|---|
| MeasObjectToRemoveList ::= | SEQUENCE (SIZE (1..maxNrofObjectId)) |

OF MeasObjectId

| | |
|---|---|
| MeasIdToRemoveList ::= | SEQUENCE (SIZE (1..maxNrofMeasId)) |

OF MeasId

| | |
|---|---|
| ReportConfigToRemoveList ::= | SEQUENCE (SIZE (1..maxReportConfigId)) |

```
OF ReportConfigId
  -- TAG-MEASCONFIG-STOP
  -- ASN1STOP
```

In operation 1e-20, the base station 1e-02 may transmit, to the UE 1e-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. Specifically, MeasObjectId always needs to be configured for each SpCell in ServingCellMO, and a base station may selectively configure MeasObjectId for each SCell in ServingCellMO. In this instance, operation 1e-20 may be performed in operation 1e-15 together, or operation 1e-15 may be performed after operation 1e-20.

In operation 1e-25, the UE 1e-01 may perform measurement based on the measurement configuration information received in operation 1e-15.

In operation 1e-30, the UE 1e-01 may determine whether to trigger a measurement report based on the measurement configuration information received in operation 1e-15. According to an embodiment of the disclosure, when at least one of the following conditions is satisfied, the UE 1e-01 may determine that triggering a measurement report is allowed. However, this is not limited to the following example.
>If the reportType is set to eventTriggered and if eventId is set to eventH1 or eventH2 and if the entry (or entering) condition applicable for this event, i.e., the event corresponding with the eventId of the corresponding reportConfig within VarMeasConfig, is fulfilled during timeToTrigger defined within the VarMeasConfig for this event, while the VarMeasReportList does not include a measurement reporting entry for this measId:
>>include a measurement reporting entry within the VarMeasReportList for this measId;
>>set the numberOfReportSent defined within the VarMeasReportList for this measId to 0;
>>initiate the measurement reporting procedure, as specified in 1e-35.
>If the reportType is set to eventTriggered and if eventId is set to eventH1 or eventH2 and if the leaving condition applicable for this event, i.e. the event corresponding with the eventId of the corresponding reportConfig within VarMeasConfig, is fulfilled during timeToTrigger defined within the VarMeasConfig for this event:
>>remove the measurement reporting entry within the VarMeasReportList for this measId;
>>If reportOnLeave is set to true for the corresponding reporting configuration:
>>>Initiate the measurement reporting procedure, as specified in 1e-35.

In this instance, a method of determining whether the UE 1e-01 satisfies the entry (or entering) condition of Event H1 or Event H2 or satisfies the leaving condition of Event H1 or Event H2 may be based on the following. However, this is not limited to the following example.

Event H1 (The Aerial UE height is above a threshold)

The UE shall:
1> consider the entering condition for this event to be satisfied when condition H1-1, as specified below, is fulfilled;
1> consider the leaving condition for this event to be satisfied when condition H1-2, as specified below, is fulfilled;

Ms−Hys>Thresh+Offset Inequality H1-1 (Entering condition)

Ms+Hys<Thresh+Offset Inequality H1-2 (Leaving condition)

The variables in the formula are defined as follows:

Ms is the Aerial UE height, not taking into account any offsets.

Hys is the hysteresis parameter (i.e. h1-Hysteresis as defined within ReportConfigNR) for this event.

Thresh is the reference threshold parameter for this event given in MeasConfig (i.e. heightThreshRef as defined within MeasConfig).

Offset is the offset value to heightThreshRef to obtain the absolute threshold for this event. (i.e. h1-ThresholdOffset as defined within ReportConfigNR)

Ms is expressed in meters.

Thresh is expressed in the same unit as Ms.

Event H2 (The Aerial UE height is below a threshold)

The UE shall:
1> consider the entering condition for this event to be satisfied when condition H2-1, as specified below, is fulfilled;
1> consider the leaving condition for this event to be satisfied when condition H2-2, as specified below, is fulfilled:

Ms+Hys<Thresh+Offset Inequality H2-1 (Entering condition)

Ms−Hys>Thresh+Offset Inequality H2-2 (Leaving condition)

The variables in the formula are defined as follows:

Ms is the Aerial UE height, not taking into account any offsets.

Hys is the hysteresis parameter (i.e. h2-Hysteresis as defined within ReportConfigNR) for this event.

Thresh is the reference threshold parameter for this event given in MeasConfig (i.e. heightThreshRef as defined within MeasConfig).

Offset is the offset value to heightThreshRef to obtain the absolute threshold for this event. (i.e. h2-ThresholdOffset as defined within ReportConfigNR)

Ms is expressed in meters.

Thresh is expressed in the same unit as Ms.

In operation 1e-35, when measurement reporting is triggered by event H1 or event H2 in operation 1e-30, the UE 1e-01 may transmit a measurement result message (MeasurementReport) to the base station 1e-02. Specifically, the UE 1e-01 may transmit the measurement result message to the base station 1e-02 according to the following procedure. However, this is not limited to the following example.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
2> if the reportConfig associated with the measId that triggered the measurement reporting includes rsType:
3> if the serving cell measurements based on the rsType included in the reportConfig that triggered the measurement report are available:
4> set the measResultServingCell within measResultServingMOList to include RSRP, RSRQ and the available SINR of the serving cell, derived based on the rsType included in the reportConfig that triggered the measurement report;
2> else:
3> if SSB based serving cell measurements are available:
4> set the measResultServingCell within measResultServingMOlist to include RSRP, RSRQ and the available SINR of the serving cell, derived based on SSB;
3> else if CSI-RS based serving cell measurements are available:
4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any,
1> if the reportConfig associated with the measId that triggered the measurement reporting includes reporQuantityRS-Indexes and maxNrofRS-IndexesToReport:
2> for each serving cell configured with servingCellMO, include beam measurement information according to the associated reportConfig as described in 5.5.5.2;
1> if the reportConfig associated with the measId that triggered the measurement reporting includes reportAddNeighMeas:
2> for each measObjectId referenced in the measIdList which is also referenced with servingCellMO, other than the measObjectId corresponding with the measId that triggered the measurement reporting:
3> if the measObjectNR indicated by the servingCellMO includes the RS resource configuration corresponding to the rsType indicated in the reportConfig:
4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR otherwise with the highest measured SINR;
4> if the reportConfig associated with the measId that triggered the measurement reporting includes reportQuantityRS-Indexes and maxNrofRS-IndexesToReport:
5> for each best non-serving cell included in the measurement report:
6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2:
2> if the UE is in NE-DC and the measurement configuration that triggered this measurement report is associated with the MCG:
3> set the measResultServFreqListEUTRA-SCG to include an entry for each E-UTRA SCG serving frequency with the following:
4> include carrierFreq of the E-UTRA serving frequency;
4> set the measResultServingCell to include the available measurement quantities that the UE is configured to measure by the measurement configuration associated with the SCG;
4> if reportConfig associated with the measId that triggered the measurement reporting includes reportAddNeighMeas:
5> set the measResultServFreqListEUTRA-SCG to include within measResultBestNeighCell the quantities of the best non-serving cell, based on RSRP, on the concerned serving frequency:
1> if reportConfig associated with the measId that triggered the measurement reporting is set to eventTriggered and eventID is set to eventA3, or eventA4, or eventA5:
2> if the UE is in NR-DC and the measurement configuration that triggered this measurement report is associated with the MCG:
3> set the measResultServFreqListNR-SCG to include for each NR SCG serving cell that is configured with servingCellMO, if any, the following:
4> if the reportConfig associated with the measId that triggered the measurement reporting includes rsType:
5> if the serving cell measurements based on the rsType included in the reportConfig that triggered the measurement report are available according to the measurement configuration associated with the SCG:
6> set the measResultServingCell within measResultServFreqListNR-SCG to include RSRP, RSRQ and the available SINR of the serving cell, derived based on the rsType included in the reportConfig that triggered the measurement report,
4> else:
5> if SSB based serving cell measurements are available according to the measurement configuration associated with the SCG:
6> set the measResultServingCell within measResultServFreqListNR-SCG to include RSRP, RSRQ and the available SINR of the serving cell, derived based on SSB;
5> else if CSI-RS based serving cell measurements are available according to the measurement configuration associated with the SCG:
6> set the measResultServingCell within measResultServFreqListNR-SCG to include RSRP, RSRQ and the available SINR of the serving cell, derived based on CSI-RS;
4> if results for the serving cell derived based on SSB are included:
5> include the ssbFrequency to the value indicated by ssbFrequency as included in the MeasObjectNR of the serving cell;
4> if results for the serving cell derived based on CSI-RS are included:
5> include the refFreqCSI-RS to the value indicated by refFreqCSI-RS as included in the MeasObjectNR of the serving cell;
4> if the reportConfig associated with the measId that triggered the measurement reporting includes reportQuantityRS-Indexes and maxNrofRS-IndexesToReport:
5> for each serving cell configured with servingCellMO, include beam measurement information according to the associated reportConfig as described in 5.5.5.2, where availability is considered according to the measurement configuration associated with the SCG;
4> if reportConfig associated with the measId that triggered the measurement reporting includes reportAddNeighMeas:
5> if the measObjectNR indicated by the servingCellMO includes the RS resource configuration corresponding to the rsType indicated in the reportConfig:
6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
7> if the reportConfig associated with the measId that triggered the measurement reporting includes reportQuantityRS-Indexes and maxNrofRS-IndexesToReport:
8> for each best non-serving cell included in the measurement report:
9> include beam measurement information according to the associated reportConfig as described in 5.5.5.2, where availability is considered according to the measurement configuration associated with the SCG;
1> if the includeCommonLocationInfo is configured in the corresponding reportConfig for this measId and detailed location information that has not been reported is available, set the content of commonLocationInfo of the locationInfo as follows:
2> include the locationTimestamp;
2> include the locationCoordinate, if available;
2> include the velocityEstimate, if available;
2> include the locationError, if available;
2> include the locationSource, if available;
2> if available, include the gnss-TOD-msec,
1> if the includeWLAN-Meas is configured in the corresponding reportConfig for this measId, set the wlan-LocationInfo of the locationInfo in the measResults as follows:
2> if available, include the LogMeasResultWAN, in order of decreasing RSSI for WLAN APs;
1> if the includeBT-Meas is configured in the corresponding reportConfig for this measId, set the BT-LocationInfo of the locationInfo in the measResults as follows:
2> if available, include the LogMeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
2> if available, include the sensor-MeasurementInformation;
2> if available, include the sensor-MotionInformation;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
2> start the periodical reporting timer with the value of reportInterval as defined within the corresponding reportConfig for this measId;
1> else:
2> if the reportType is set to periodical or cli-Periodical or rxTxPeriodical:
3> remove the entry within the VarMeasReportList for this measId;
3> remove this measId from the measIdList within VarMeasConfig;
1> else if the UE is in (NG)EN-DC:
2> if SRB3 is configured and the SCG is not deactivated:
3> submit the MeasurementReport message via SRB3 to lower layers for transmission, upon which the procedure ends;
2> else:
3> submit the MeasurementReport message via F-UTRA embedded in E-UTRA RRC message ULInformationTransferMRDC as specified in TS 36.331 [10].
1> else if the UE is in NR-DC:
2> if the measurement configuration that triggered this measurement report is associated with the SCG:
3> if SRB3 is configured and the SCG is not deactivated:
4> submit the MeasurementReport message via SRB3 to lower layers for transmission, upon which the procedure ends;
3> else:
4> submit the MeasurementReport message via SRB1 embedded in NR RRC message ULInformationTransferMRDC as specified in 5.7.2a 3;
2> else:
3> submit the MeasurementReport message via SRB1 to lower layers for transmission, upon which the procedure ends;
1> else:
2> submit the MeasurementReport message to lower layers for transmission, upon which the procedure ends.

In this instance, the UE 1e-01 may include a beam measurement result in MeasurementReport according to the following procedure.

For beam measurement information to be included in a measurement report the UE shall:
1> if reportType is set to eventTriggered:
2> consider the trigger quantity as the sorting quantity if available, otherwise RSRP as sorting quantity if available, otherwise RSRQ as sorting quantity if available, otherwise SINR as sorting quantity:
1> set rsIndexResults to include up to maxNrofRS-IndexesToReport SS/PBCH block indexes or CSI-RS indexes in order of decreasing sorting quantity as follows:
2> if the measurement information to be included is based on SS/PBCH block:
3> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
3> if includeBeamMeasurements is set to true, include the SS/PBCH based measurement results for the quantities in reportQuantityRS-Indexes for each SS/PBCH block index;
2> else if the beam measurement information to be included is based on CSI-RS:
3> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
3> if includeBeamMeasurements is set to true, include the CSI-RS based measurement results for the quantities in reportQuantityRS-Indexes for each CSI-RS index.

That is, when measurement reporting is triggered by event H1 or event H2, the UE 1e-01 according to an embodiment of the disclosure may have the following features when transmitting MeasurementReport to the base station 1e-02. However, this is not limited to the following example.
including measResultServingCellMOList
excluding measResultNeighCells
excluding measResultServFreqListEUTRA-SCG
excluding measResultServFreqListNR-SCG

For reference, MeasResults included in MeasurementReport may be provided in the following ASN.1 structure. However, this is not limited to the following example.

| MeasResults ::= | | SEQUENCE { | |
|---|---|---|---|
| measId | | MeasId, | |
| measResultServingMOList | | MeasResultServMOList, | |
| measResultNeighCells | | CHOICE { | |
| | measResultListNR | MeasResultListNR, | |
| | ..., | | |
| | measResultListEUTRA | MeasResultListEUTRA, | |
| | measResultListUTRA-FDD-r16 | MeasResultListUTRA-FDD-r16, | |
| | sl-MeasResultsCandRelay-r17 | OCTET STRING | -- |

```
Contains PC5 SL-MeasResultListRelay-r17
      }
OPTIONAL,
      ...,
      [[
```

| | |
|---|---|
| measResultServFreqListEUTRA-SCG | MeasResultServFreqListNR-SCG |
| SCG | OPTIONAL, |
| measResultServFreqListNR-SCG | MeasResultServFreqListNR-SCG |

OPTIONAL,

| | |
|---|---|
| measResultsSFTD-EUTRA | MeasResultSFTD-EUTRA |

OPTIONAL,

| | |
|---|---|
| measResultsSFTD-NR | MeasResultCellSFTD-NR |

```
OPTIONAL
        ]],
        [[
```

| | |
|---|---|
| measResultCellListSFTD-NR | MeasResultListSFTD-NR |

```
OPTIONAL
      ]],
      [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
      ]],
      [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,
-- Contains PC5-ExcessDelayResultList-r17

| | |
|---|---|
| ul-PDCP-ExcessDelayResultList-r17 | UL-PDCP-ExcessDelayResultList-r17 |

OPTIONAL,

| | |
|---|---|
| courseLocationInfo-r17 | OCTET STRING |

```
OPTIONAL
      ]]
  }
```

| | |
|---|---|
| MeasResultServMOList ::= | SEQUENCE (SIZE |

(1..maxNrofServingCells)) OF MeasResultServMO

| | |
|---|---|
| MeasResultServMO ::= | SEQUENCE { |
| servCellId | ServCellIndex, |
| measResultServingCell | MeasResultNR, |

| | |
|---|---|
| measResultBestNeighCell | MeasResultNR |

```
OPTIONAL,
      ...
  }
```

| | |
|---|---|
| MeasResultListNR ::= | SEQUENCE (SIZE (1..maxCellReport)) OF |

MeasResultNR

| | |
|---|---|
| MeasResultNR ::= | SEQUENCE { |

| | |
|---|---|
| physCellId | PhysCellId |

OPTIONAL,

| measResult | | SEQUENCE { |
|---|---|---|
| | cellResults | SEQUENCE{ |

| | |
|---|---|
| resultsSSB-Cell | MeasQuantityResults |

OPTIONAL,

| | |
|---|---|
| resultsCSI-RS-Cell | MeasQuantityResults |

OPTIONAL

| }, | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

OPTIONAL

}

```
OPTIONAL
      },
      ...,
      [[
```

| | |
|---|---|
| cgi-Info | CGI-InfoNR |

```
OPTIONAL
      ]],
      [[
```

| | |
|---|---|
| choCandidate-r17 | ENUMERATED {true} |

OPTIONAL,

| | |
|---|---|
| choConfig-r17 | SEQUENCE (SIZE (1..2)) OF |
| CondTriggerConfig-r16 | OPTIONAL, |
| triggeredEvent-r17 | SEQUENCE { |

| | |
|---|---|
| timeBetweenEvents-r17 | TimeBetweenEvent-r17 |

OPTIONAL,

| | |
|---|---|
| firstTriggeredEvent | ENUMERATED {condFirstEvent, |

| | |
|---|---|
| condSecondEvent} | OPTIONAL |
| | } |

```
OPTIONAL
      ]]
  }
```

| | |
|---|---|
| MeasResultListEUTRA ::= | SEQUENCE (SIZE (1..maxCellReport)) OF |

MeasResultEUTRA

| | |
|---|---|
| MeasResultEUTRA ::= | SEQUENCE { |
| eutrea-PhysCellId | PhysCellId, |
| measResult | MeasQuantityResultsEUTRA, |

| | |
|---|---|
| cgi-Info | CGI-InfoEUTRA |

```
OPTIONAL,
      ...
  }
```

| | |
|---|---|
| MultiBandInfoListEUTRA ::= | SEQUENCE (SIZE (1..maxMultiBands)) OF |

FreqBandIndicatorEUTRA

| | |
|---|---|
| MeasQuantityResults ::= | SEQUENCE { |

| | |
|---|---|
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |

| | |
|---|---|
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE |

(1..maxNrofIndexesToReport2)) OF ResultsPerSSB-Index

| | |
|---|---|
| ResultsPerSSB-Index ::= | SEQUENCE { |

| | |
|---|---|
| ssb-Index | SSB-Index, |

| | |
|---|---|
| ssb-Results | MeasQuantityResults |

OPTIONAL
}

| | |
|---|---|
| ResultsPerCSI-RS-IndexList::= | SEQUENCE (SIZE |

(1..maxNrofIndexesToReport2)) OF ResultsPerCSI-RS-Index

| | |
|---|---|
| ResultsPerCSI-RS-Index ::= | SEQUENCE { |

| | |
|---|---|
| csi-RS-Index | CSI-RS-Index, |

| | |
|---|---|
| csi-RS-Results | MeasQuantityResults |

OPTIONAL
}

| | | |
|---|---|---|
| MeasResultServFreqListEUTRA-SCG | ::= SEQUENCE | (SIZE |

(1..maxNrofServingCellsEUTRA)) of MeasResult2EUTRA
MeasResultServFreqListNR-SCG ::= SEQUENCE (SIZE (1..maxNrofServingCells)) OF
MeasResult2NR

| | |
|---|---|
| MeasResultListUTRA-FDD-r16 ::= | SEQUENCE (SIZE (1..maxCellReport)) OF |

MeasResultUTRA-FDD-r16

| | |
|---|---|
| MeasResultUTRA-FDD-r16 ::= | SEQUENCE { |
| physCellId-r16 | PhysCellIdUTRA-FDD-r16, |
| measResult-r16 | SEQUENCE { |

| | |
|---|---|
| utra-FDD-RSCP-r16 | INTEGER (−5..91) |

OPTIONAL,

| | |
|---|---|
| utra-FDD-EcN0-r16 | INTEGER (0..49) |

```
OPTIONAL
      }
  }
```

| | |
|---|---|
| MeasResultForRSSI-r16 ::= | SEQUENCE { |
| rssi-Result-r16 | RSSI-Range-r16, |
| channelOccupancy-r16 | INTEGER (0..100) |

}

| | |
|---|---|
| MeasResultCLI-r16 ::= | SEQUENCE { |

| | |
|---|---|
| measResultListSRS-RSRP-r16 | MeasResultListSRS-RSRP |

OPTIONAL,

| | |
|---|---|
| measResultCLI-RSSI-r16 | MeasResultCLI-RSSI-r16 |

```
OPTIONAL
  }
  MeasResultListSRS-RSRP-r16 ::= SEQUENCE (SIZE (1.. maxCLI-Report-r16)) OF
MeasResultSRS-RSRP-r16
```

| | |
|---|---|
| MeasResultSRS-RSRP-r16 ::= | SEQUENCE { |
| srs-ResourceId-r16 | SRS-ResourceId, |
| srs-RSRP-Result-r16 | SRS-RSRP-Range-r16 |

}

| | |
|---|---|
| MeasResultListCLI-RSSI-r16 ::= | SEQUENCE (SIZE (1.. maxCLI-Report-r16)) OF |

MeasResultCLI-RSSI-r16

| | |
|---|---|
| MeasResultCLI-RSSI-r16 ::= | SEQUENCE { |
| rssi-ResourceId-r16 | RSSI-ResourceId-r16, |
| cli-RSSI-Result-r16 | CLI-RSSI-Range-r16 |

```
  }
  UL-PDCP-Delay ValueResultList-r16 ::= SEQUENCE (SIZE (1..maxDRB)) OF UL-PDCP-
DelayValueResult-r16
  UL-PDCP-Delay ValueResult-r16 ::= SEQUENCE {
```

| | |
|---|---|
| drb-Id-r16 | DRB-Identity |
| averageDelay-r16 | INTEGER (0..10000), |

```
      ...
  }
  UL-PDCP-ExcessDelayResultList-r17 := SEQUENCE (SIZE (1..maxDRB)) OF UL-PDCP-
ExcessDelay Result-r17
  UL-PDCP-ExcessDelayResult-r17 ::= SEQUENCE {
```

| | |
|---|---|
| drb-Id-r17 | DRB-Identity, |
| excessDelay-r17 | INTEGER (0..31), |

```
      ...
    }
  TimeBetweenEvent-r17 ::= INTEGER (0..1023)
  -- TAG-MEASRESULTS-STOP
  -- ASN1STOP
```

FIG. 1F is a flowchart illustrating a process in which an uncrewed aerial vehicle (UAV) user equipment (UE) transmits a height event-based measurement result message to a base station in a next generation mobile communication system according to an embodiment of the disclosure.

Referring to FIG. 1F, a UAV UE 1f-01 may be in an RRC connected mode (RRC_CONNECTED) by configuring an RRC connection with an NR base station 1f-02. In the following description of FIG. 1F, a description that overlaps with the description that has been provided in FIG. 1E may be omitted.

In operation 1f-10, the UE 1f-01 may transmit a UE capability information message (UECapabilityInformation) to the base station 1f-02. Operation 1f-10 may be performed according to the above-described embodiment (e.g., operation 1e-10). In addition, the UE capability information message (UECapabilityInformation) may include an indicator indicating capability to exclude measResultServingCellMOList from a measurement result message (MeasurementReport) when measurement reporting is triggered by Event H1 and/or Event H2. Alternatively, the UE capability information message (UECapabilityInformation) may include an indicator indicating capability to include measResultServingCellMOList only for an SpCell (a PCell only, a PSCell only, or at least one PCell and a PSCell) in a measurement result message (MeasurementReport) and exclude a measurement result for a serving cell configured as the remaining ServingCellMO when measurement reporting is triggered by Event H1 and/or Event H2.

In operation 1f-15, the base station 1f-02 may transmit a predetermined RRC message (e.g., RRCReconfiguration) including measurement configuration information (MeasConfig) to the UE 1f-01. Operation 1f-15 may be performed according to the above-described embodiment (e.g., operation 1e-15). Alternatively, in the disclosure, when measurement reporting is triggered by Event H1 and/or Event H2 according to the measurement configuration information, in the measurement configuration information, an indicator indicating that the UE needs to exclude measResultServingCellMOList from a measurement result message (MeasurementReport) or an indicator indicating that the UE needs to include measResultServingCellMOList only for an SpCell (a PCell only, a PSCell only, or at least one PCell and a PSCell) in measResultServingCellMOList and needs to exclude a measurement result for a serving cell configured as the remaining ServingCellMO. This may mean that transmission of a measurement result message including information only for the SpCell in measResultServingCellMOList is required. The above-described indicator may be included in a predetermined field (e.g., report configuration information) in MeasConfig.

In operation 1f-20, the base station 1f-02 may transmit, to the UE 1f-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. Operation 1f-20 may be performed according to the above-described embodiment (e.g., operation 1e-20). The indicator described in operation 1f-15 may be configured for each CellGroupConfig or for each SCell in operation 1f-20.

In operation 1f-25, the UE 1f-01 may perform measurement based on the measurement configuration information received in operation 1f-15.

In operation 1f-30, the UE 1f-01 may determine whether to trigger a measurement report based on the measurement configuration information received in operation 1f-15. Operation 1f-30 may be performed according to the above-described embodiment (e.g., operation 1e-30).

In operation 1f-35, when measurement reporting is triggered by event H1 or event H2 in operation 1f-30, the UE 1f-01 may transmit a measurement result message (MeasurementReport) to the base station 1f-02. In operation 1f-35, the UE 1f-01 transmits the measurement result message to the base station 1f-02 according to the above-described embodiment (e.g., 1e-35), and, in this instance, when the indicator described in operation 1f-15 or 1f-20 is configured for the UE 1f-01, the UE 1f-01 may have the following features when transmitting MeasurementReport to the base station 1f-02.
According to a configuration of the base station 1f-02, including measResultServingCellMOList only for an SpCell or excluding measResultServingCellMOList.
Excluding measResultNeighCells.
Excluding measResultServFreqListEUTRA-SCG.
Excluding measResultServFreqListNR-SCG.

FIG. 1G is a flowchart illustrating a process in which an uncrewed aerial vehicle (UAV) user equipment (UE) transmits a height event-based measurement result message to a base station in a next generation mobile communication system according to an embodiment of the disclosure.

Referring to FIG. 1G, a UAV UE 1g-01 may be in an RRC connected mode (RRC_CONNECTED) by configuring an RRC connection with an NR base station 1g-02. In the following description of FIG. 1G, a description that overlaps with the description that has been provided in FIGS. 1E and 1F may be omitted.

In operation 1g-10, the UE 1g-01 may transmit a UE capability information message (UECapabilityInformation) to the base station 1g-02. Operation 1g-10 may be performed according to the above-described embodiment (e.g., operation 1e-10). In addition, the UE capability information message (UECapabilityInformation) may include an indicator indicating capability to exclude predetermined measResultServingCellMO(s), according to a configuration of the base station, from a measurement result message (MeasurementReport) when measurement reporting is triggered by Event H1 and/or Event H2.

In operation 1g-15, the base station 1g-02 may transmit a predetermined RRC message (e.g., RRCReconfiguration) including measurement configuration information (MeasConfig) to the UE 1g-01. Operation 1g-15 may be performed according to the above-described embodiment (e.g., operation 1e-15). In addition, in the disclosure, the measurement configuration information may include an information element indicating that the UE needs to exclude measResultServingCellMO for one or multiple indicated ServingCellMOs (e.g., by indicating one or multiple MeasObjectIds respectively mapped to ServingCellMOs) from a measurement result message (MeasurementReport) when measurement reporting is triggered by Event H1 and/or Event H2 according to the measurement configuration information. Alternatively, the information element may be included in a predetermined field in MeasConFIG. In this instance, the information element may include an indicator indicating a need for excluding measResultServingCellMO for all ServingCellMOs, or may include an indicator indicating a need for excluding measResultServingCellMO only for an SpCell (or alternatively, the information element may act as an explicit indicator by not including any information). This may mean that inclusion of measResultServingCellMO in the measurement result message, only for one or multiple serving cells (ServingCellMOs) that the base station 1g-02 is interested in, is required.

In operation 1g-20, the base station 1g-02 may transmit, to the UE 1g-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. This may be performed according to the above-described embodiment. The indicator described in operation 1g-15 may be configured for each CellGroupConfig or for each SCell in operation 1g-20.

In operation 1g-25, the UE 1g-01 may perform measurement based on the measurement configuration information received in operation 1g-15.

In operation 1g-30, the UE may determine whether to trigger a measurement report based on the measurement configuration information received in operation 1g-15. Operation 1g-30 may be performed according to the above-described embodiment (e.g., operation 1e-30).

In operation 1g-35, when measurement reporting is triggered by event H1 or event H2 in operation 1g-30, the UE 1g-01 may transmit a measurement result message (MeasurementReport) to the base station 1g-02. The UE 1g-01 transmits the measurement result message to the base station 1g-02 according to the above-described embodiment (e.g., 1e-35), and, in this instance, when the indicator described in operation 1g-15 or 1g-20 is configured for the UE 1g-01, the UE 1g-01 may have the following features when transmitting MeasurementReport to the base station 1g-02. However, this is not limited to the following example.
According to a configuration of the base station, excluding measResultServingCellMO for one or multiple ServingCellMOs. That is, measResultServingCellMO is included for the remaining ServingCellMO(s).
Excluding measResultNeighCells.
Excluding measResultServFreqListEUTRA-SCG.
Excluding measResultServFreqListNR-SCG.

FIG. 1H is a flowchart illustrating a process in which an uncrewed aerial vehicle (UAV) user equipment (UE) transmits a height event-based measurement result message to a base station in a next generation mobile communication system according to an embodiment of the disclosure.

Referring to FIG. 1H, a UAV UE 1h-01 may be in an RRC connected mode (RRC_CONNECTED) by configuring an RRC connection with an NR base station 1h-02. In the following description associated with FIG. 1H, a description that overlaps with the description that has been provided in FIGS. 1E to 1G may be omitted.

In operation 1h-10, the UE 1h-01 may transmit a UE capability information message (UECapabilityInformation) to the base station 1h-02. Operation 1h-10 may be performed according to at least one of the above-described embodiments (e.g., operations 1e-10, 1f-10, and 1g-10). In addition, when the UE 1h-01 is NE-DC, the UE capability information message (UECapabilityInformation) may include capability information indicating capability to include measResultServFreqListEUTRA-SCG in a measurement result message when measurement reporting is triggered by event H1 or event H2 according to measurement configuration information of an MCG. In addition, when the UE 1h-01 is NR-DC, the UE capability information message (UECapabilityInformation) may include capability information indicating capability to include measResultServFreqListNR-SCG in a measurement result message when measurement reporting is triggered by event H1 or event H2 according to measurement configuration information of the MCG.

In operation 1h-15, the UE 1h-01 may be configured with NE-DC or NR-DC by receiving a predetermined RRC message (e.g., RRCReconfiguration) from the base station 1h-02 or 1h-03.

In operation 1h-20, the base station 1h-02 may transmit a predetermined RRC message (e.g., RRCReconfiguration) including measurement configuration information (MeasConfig) to the UE 1h-01. Operation 1h-20 may be performed according to at least one of the above-described embodiments (e.g., operations 1e-15, 1f-15, and 1g-15). The measurement configuration information may be configured for each CellGroup. In this instance, measurement configuration information for a secondary cell group may be directly provided from the base station 1h-03 to the UE 1h-01. In the measurement configuration information, when the UE 1h-01 is NE-DC, an indicator indicating a need for including measResultServFreqListEUTRA-SCG in a measurement result message may be included, when measurement reporting is triggered by event H1 or event H2 according to the measurement configuration information of the MCG. In the measurement configuration information, when the UE 1h-01 is NR-DC, an indicator indicating a need for including measResultServFreqListNR-SCG in a measurement result message may be included, when measurement reporting is triggered by event H1 or event H2 according to the measurement configuration information of the MCG.

In operation 1h-25, the base station 1h-02 may transmit, to the UE 1h-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. Operation 1h-25 may be performed according to at least one of the above-described embodiments (e.g., operations 1e-20, 1f-20, and 1g-20). For reference, cell group information for a secondary cell group may be provided directly from the base station 1h-03 to the UE.

In operation 1h-30, the UE 1h-01 may perform measurement based on the measurement configuration information received in operation 1h-20.

In operation 1h-35, the UE 1h-01 may determine whether to trigger a measurement report based on the measurement configuration information received in operation 1h-20. Operation 1h-35 may be performed according to at least one of the above-described embodiments (e.g., operations 1e-30, 1f-30, and 1g-30).

In operation 1h-40, when measurement reporting is triggered by event H1 or event H2 in operation 1h-30, the UE 1h-01 may transmit a measurement result message (MeasurementReport) to the base station 1h-02. Operation 1h-40 may be performed according to at least one of the above-described embodiments (e.g., operations 1e-35, 1f-35, and 1g-35). In addition, in the disclosure, when the UE 1h-01 is NE-DC (NR-DC) and a measurement configuration triggered by measurement reporting is associated with the MCG, measResultServFreqListEUTRA-SCG (measResultServFreqListNR-SCG) may be included in the measurement result message and may be transmitted to the base station 1h-02. The UE 1h-01 according to the disclosure may include the following information in the measurement result message, unlike the above-described embodiment.
When the UE 1h-01 is NE-DC and event H1 or event H2 is triggered in the MCG measurement configuration information, the measurement result message may include measResultServFreqListEUTRA-SCG. Information included in the measurement result message may be based on a base station configuration or UE capability. Alternatively, the measurement result message may always include measResultServFreqListEUTRA-SCG.
When the UE 1h-01 is NR-DC and event H1 or event H2 is triggered in the MCG measurement configuration information, measResultServFreqListNR-SCG may be included. Information included in the measurement result message may be based on a base station configuration or UE capability. Alternatively, the measurement result message may always include measResultServFreqListNR-SCG.

FIG. 1I is a flowchart illustrating a process in which an uncrewed aerial vehicle (UAV) user equipment (UE) transmits a height event-based measurement result message to a base station in a next generation mobile communication system according to an embodiment of the disclosure.

Referring to FIG. 1I, a UAV UE 1i-01 may be in an RRC connected mode (RRC_CONNECTED) by configuring an RRC connection with an NR base station 1i-02. In the following description associated with FIG. 1I, a description that overlaps with the description that has been provided in FIGS. 1E to 1H may be omitted.

In operation 1i-10, the UE 1i-01 may transmit a UE capability information message (UECapabilityInformation) to the base station 1i-02. Operation 1i-10 may be performed according to at least one of the above-described embodiments (e.g., operations 1e-10, 1f-10, 1g-10, and 1h-10). In addition, when the UE 1i-01 is NE-DC, the UE capability information message (UECapabilityInformation) may include capability information indicating capability to exclude measResultServFreqListEUTRA-SCG from a measurement result message or capability information indicating capability to include only MeasResult2EUTRA for a PSCell in measResultServFreqListEUTRA-SCG within the measurement result message, when measurement reporting is triggered by event H1 or event H2 according to measurement configuration information of an MCG. In addition, when the UE 1i-01 is NR-DC, the UE capability information message (UECapabilityInformation) may include capability information indicating whether to exclude measResultServFreqListNR-SCG from a measurement result message or capability information indicating capability to include only MeasResult2NR for a PSCell in measResultServFreqListNR-SCG within the measurement result message, when measurement reporting is triggered by event H1 or event H2 according to measurement configuration information of the MCG.

In operation 1i-15, the UE 1i-01 may be configured with NE-DC or NR-DC by receiving a predetermined RRC message (e.g., RRCReconfiguration) from the base station 1i-02 or 1i-03.

In operation 1i-20, the base station 1i-02 may transmit a predetermined RRC message (e.g., RRCReconfiguration) including measurement configuration information (MeasConfig) to the UE 1i-01. Operation 1i-20 may be performed according to at least one of the above-described embodiments (e.g., operations 1e-15, 1f-15, 1g-15, and 1h-20). In the measurement configuration information, when the UE 1i-01 is NE-DC, an indicator indicating a need for excluding measResultServFreqListEUTRA-SCG from a measurement result message or an indicator indicating a need for including only MeasResult2EUTRA for a PSCell in measResultServFreqListEUTRA-SCG in the measurement result message may be included, when measurement reporting is triggered by event H1 or event H2 according to the measurement configuration information of the MCG. In the measurement configuration information, when the UE 1i-01 is NR-DC, an indicator indicating a need for excluding measResultServFreqListNR-SCG from a measurement result message or an indicator indicating a need for including only MeasResult2NR for a PSCell in measResultServFreqListNR-SCG in the measurement result message may be included, when measurement reporting is triggered by event H1 or event H2 according to the measurement configuration information of the MCG.

In operation 1i-25, the base station 1i-02 or 1i-03 may transmit, to the UE 1i-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. Operation 1i-25 may be performed according to at least one of the above-described embodiments (e.g., operations 1e-20, 1f-20, 1g-20, and 1h-25). For reference, cell group information for a secondary cell group may be directly provided from the base station 1i-03 to the UE 1i-01.

In operation 1i-30, the UE 1i-01 may perform measurement based on the measurement configuration information received in operation 1i-20.

In operation 1i-35, the UE 1i-01 may determine whether to trigger a measurement report based on the measurement configuration information received in operation 1i-20. Operation 1i-35 may be performed according to at least one of the above-described embodiments (e.g., operations 1e-30, 1f-30, 1g-30, and 1h-35).

In operation 1i-40, when measurement reporting is triggered by event H1 or event H2 in operation 1i-30, the UE 1i-01 may transmit a measurement result message (MeasurementReport) to the base station 1i-02. Operation 1i-40 may be performed according to at least one of the above-described embodiments (e.g., operations 1e-35, 1f-35, 1g-35, and 1h-40). In the disclosure, when the UE i1-01 is NE-DC (NR-DC) and a measurement configuration triggered by measurement reporting is associated with the MCG, the UE i1-01 may exclude measResultServFreqListEUTRA-SCG (measResultSErvFreqListNR-SCG) from the measurement result message according to the configuration of the base station 1i-02 (i.e., for which EUTRA serving cell a measurement result is to be included according to the configuration of the base station 1i-02), or may include measResultServFreqListEUTRA-SCG (measResultSErvFreqListNR-SCG) only for a PSCell in the measurement result message, and may transmit the measurement result message to the base station 1i-02.

FIG. 1J is a flowchart illustrating a process in which an uncrewed aerial vehicle (UAV) user equipment (UE) transmits a height event-based measurement result message to a base station in a next generation mobile communication system according to an embodiment of the disclosure.

Referring to FIG. 1J, a UAV UE 1j-01 may be in an RRC connected mode (RRC_CONNECTED) by configuring an RRC connection with an NR base station 1j-02. In the following description associated with FIG. 1J, a description that overlaps with the description that has been provided in FIGS. 1E to 1I may be omitted.

In operation 1j-10, the UE 1j-01 may transmit a UE capability information message (UECapabilityInformation) to the base station 1j-02. Operation 1j-10 may be performed according to at least one of the above-described embodiments (e.g., operations 1e-10, 1f-10, 1g-10, 1h-10, and 1i-10). In addition, when the UE is NE-DC, the UE capability information (UECapabilityInformation) may include a capability information element that includes MeasResult2EUTRA only for serving cells requested by a base station among serving cells configured in a secondary node (SN), in measResultServFreqListEUTRA-SCG within a measurement result message, when measurement reporting is triggered by event H1 or event H2 according to measurement configuration information of an MCG. In addition, when the UE is NR-DC, the UE capability information (UECapabilityInformation) may include a capability information element that includes MeasResult2NR only for serving cells requested by a base station among serving cells configured in the secondary node (SN), in measResultServFreqListNR-SCG within a measurement result message, when measurement reporting is triggered by event H1 or event H2 according to measurement configuration information of the MCG.

In operation 1j-15, the UE 1j-01 may be configured with NE-DC or NR-DC by receiving a predetermined RRC message (e.g., RRCReconfiguration) from the base station 1j-02 or 1j-03.

In operation 1j-20, the base station 1j-02 may transmit a predetermined RRC message (e.g., RRCReconfiguration) including measurement configuration information (MeasConfig) to the UE 1j-01. Operation 1j-20 may be performed according to at least one of the above-described embodiments (e.g., operations 1e-15, 1f-15, 1g-15, 1h-20, and 1i-20). In the measurement configuration information, when the UE is NE-DC, information indicating that only for which serving cells MeasResult2EUTRA needs to be included in measResultServFreqListEUTRA-SCG and a measurement result message needs to be transmitted to the base station 1j-02 may be included when measurement reporting is triggered by event H1 or event H2 according to measurement configuration information of the MCG. In the measurement configuration information, when the UE 1j-01 is NR-DC, information indicating that only for which serving cells MeasResult2NR needs to be included in measResultServFreqListNR-SCG and a measurement result message needs to be transmitted to the base station 1j-02 may be included when measurement reporting is triggered by event H1 or event H2 according to measurement configuration information of the MCG.

In operation 1j-25, the base station 1j-02 or 1j-03 may transmit, to the UE 1j-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. Operation 1j-25 may be performed according to at least one of the above-described embodiments (e.g., operations 1e-20, 1f-20, 1g-20, 1h-25, and 1i-25). For reference, cell group information for a secondary cell group may be provided directly from the base station 1j-03 to the UE.

In operation 1j-30, the UE 1j-0l may perform measurement based on the measurement configuration information received in operation 1j-20.

In operation 1j-35, the UE may determine whether to trigger a measurement report based on the measurement configuration information received in operation 1j-20. Operation 1j-35 may be performed according to at least one of the above-described embodiments (e.g., operations 1e-30, 1f-30, 1g-30, 1h-35, and 1i-35).

In operation 1j-40, when measurement reporting is triggered by event H1 or event H2 in operation 1j-30, the UE 1j-01 may transmit a measurement result message (MeasurementReport) to the base station 1j-02. Operation 1j-40 may be performed according to at least one of the above-described embodiments (e.g., operations 1e-35, 1f-35, 1g-35, 1b-40, and 1h-40). In the disclosure, when the UE is NE-DC and a measurement configuration triggered by measurement reporting is associated with the MCG, the UE may include measResultServFreqListEUTRA-SCG in a measurement result message according to the configuration of the base station 1j-02 in operation 1j-20 and may transmit the measurement result message to the base station. In the disclosure, when the UE is NR-DC and a measurement configuration triggered by measurement reporting is associated with the MCG, the UE may include measResultSErvFreqListNR-SCG in a measurement result message according to the configuration of the base station 1j-02 in operation 1j-20 and may transmit the measurement result message to the base station 1j-02.

FIG. 1K is a flowchart illustrating a process in which an uncrewed aerial vehicle (UAV) user equipment (UE) transmits a height event-based measurement result message to a base station in a next generation mobile communication system according to an embodiment of the disclosure.

Referring to FIG. 1K, a UAV UE 1k-01 may be in an RRC connected mode (RRC_CONNECTED) by configuring an RRC connection with an NR base station 1k-02. In the following description associated with FIG. 1K, a description that overlaps with the description that has been provided in FIGS. 1E to 1J may be omitted.

In operation 1k-10, the UE 1k-01 may transmit a UE capability information message (UECapabilityInformation) to the base station 1k-02. Operation 1k-10 may be performed according to at least one of the above-described embodiments (e.g., operations 1e-10, 1f-10, 1g-10, 1h-10, 1i-10, and 1j-10). In addition, the UE capability information message (UECapabilityInformation) may include capability information indicating whether MeasResultListNR information is capable of being included in measResultNeighCells when measurement reporting is triggered by Event H1 or Event H2.

In operation 1k-15, the base station 1k-02 may transmit a predetermined RRC message (e.g., RRCReconfiguration) including measurement configuration information (MeasConfig) to the UE 1k-01. Operation 1k-15 may be performed according to at least one of the above-described embodiments (e.g., operations 1e-15, 1f-15, 1g-15, 1h-20, 1i-20, and 1j-20). The measurement configuration information may include an indicator indicating a need for including MeasResultListNR information in measResultNeighCells when measurement reporting is triggered by Event H1 or Event H2.

In operation 1k-20, the base station 1k-02 may transmit, to the UE 1k-01, a predetermined RRC message (e.g., RRCReconfiguration) including cell group configuration information (CellGroupConfig) to configure a single or multiple secondary cells (SCells) and/or Spcell cells (SpCells). CellGroupConfig may include UE-dedicated configuration information (ServingCellConfig) for each cell, and MeasObjectId may be configured in ServingCellMO for each ServingCellConFIG. Operation 1k-25 may be performed according to at least one of the above-described embodiments (e.g., operations 1e-20, 1f-20, 1g-20, 1h-25, 1i-25, and 1j-25).

In operation 1k-25, the UE 1k-01 may perform measurement based on the measurement configuration information received in operation 1k-20.

In operation 1k-30, the UE 1k-01 may determine whether to trigger a measurement report based on the measurement configuration information received in operation 1k-20. Operation 1k-30 may be performed according to at least one of the above-described embodiments (e.g., operations 1e-30, 1f-30, 1g-30, 1h-35, 1i-35, and 1j-35).

In operation 1k-35, when measurement reporting is triggered by event H1 or event H2 in operation 1k-30, the UE 1k-01 may transmit a measurement result message (MeasurementReport) to the base station 1k-02. Operation 1k-35 may be performed according to at least one of the above-described embodiments (e.g., operations 1e-35, 1f-35, 1g-35, 1b-40, 1i-40, 1j-40, and 1j-40). In the disclosure, the UE 1k-01 may transmit, to the base station 1k-02, a measurement result message in which MeasResultListNR information is included in measResultNeighCells according to reportQuantityCell and maxReportCells. The UE 1k-01 may include cells belonging to cellTriggeredList in measResultNeighCells, or may employ a new UE variable and include cells belonging to the corresponding variable in measResultNeighCells. The UE 1k-01 may include as many best neighboring cells as a maximum measResultNeighCells in measResultNeighCells, and a detailed operation thereof is as follows. However, this is not limited to the following example.
for each cell that is included in the measResultNeighCells, include the physCellId;
>for each included cell, include the layer 3 filtered measured results in accordance with the reportConfig for this measId, ordered as follows:
>>if rsType in the associated reportConfig is set to ssb:
>>>set resultsSSB-Cell within the measResult to include the SS/PBCH block based quantity(ies) indicated in the reportQuantityCell within the concerned reportConfig, in decreasing order of the sorting quantity i.e. the best cell is included first,
>>>if reportQuantityRS-Indexes and maxNrofRS-IndexesToReport are configured, include beam measurement information as described in 1e-35;
>>else if rsType in the associated reportConfig is set to csi-rs:
>>set resultsCSI-RS-Cell within the measResult to include the CSI-RS based quantity(ies) indicated in the reportQuantityCell within the concerned reportConfig, in decreasing order of the sorting quantity i.e. the best cell is included first;
if reportQuantityRS-Indexes and maxNrofRS-IndexesToReport are configured, include beam measurement information as described in 1e-35;

In this instance, sorting quantity for the cell measurement result may be as shown below.
Determine the sorting quantity according to reportQuantityCell for an NR cell as follows:
>if a single quantity is set to true:
>>consider this quantity as the sorting quantity;
>else:
>>if reference signal received power (RSRP) is set to true:
>>>consider RSRP as the sorting quantity:
>>else:
>>>consider reference signal received quality (RSRQ) as the sorting quantity;

FIG. 1L illustrates an internal structure of a UE according to an embodiment of the disclosure.

Referring to FIG. 1L, the UE may include a radio frequency (RF) processor 1l-10, a baseband processor 1l-20, a storage 1l-30, and a controller 1l-40. Of course, the example given above is not limiting, and the UE may include a smaller or larger number of components than the components illustrated in FIG. 1L.

The RF processor 1l-10 may perform a function for transmitting and receiving a signal via a wireless channel, such as band conversion and amplification of the signal. That is, the RF processor 1l-10 may up-convert a baseband signal provided from the baseband processor 1l-20 to an RF band signal, may transmit the same through an antenna, and may down-convert an RF band signal received through the antenna to a baseband signal. For example, the RF processor 1l-10 may include a transmission filter, a reception filter, an amplifier, a mixer, an oscillator, a digital-to-analog converter (DAC), an analog-to-digital converter (ADC), and the like. Although only one antenna is illustrated in FIG. 1L, the UE may include multiple antennas. In addition, the RF processor 1l-10 may include multiple RF chains. Moreover, the RF processor 1l-10 may perform beamforming. For the beamforming, the RF processor 1l-10 may adjust the phase and size of each of the signals transmitted or received through a plurality of antennas or antenna elements. In addition, the RF processor 1l-10 may perform MIMO, and may receive several layers when an MIMO operation is performed.

The baseband processor 1i-20 may perform functions of conversion between baseband signals and bitstrings according to the system's physical layer specifications. For example, during data transmission, the baseband processor 1l-20 may generate complex symbols by encoding and modulating a transmission bit stream. In addition, during data reception, the baseband processor 1l-20 may reconstruct a reception bitstring by demodulating and decoding a baseband signal provided from the RF processor 1l-10. For example, when following the orthogonal frequency division multiplexing (OFDM) scheme, during data transmission, the baseband processor 1l-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 1l-20 may split a baseband signal provided from the RF processor 1l-10 at the OFDM symbol level, may restore signals mapped to subcarriers through a fast Fourier transform (FFT) operation, and may restore a received bitstring through demodulation and decoding.

The baseband processor 1l-20 and the RF processor 1l-10 may transmit and receive signals as described above. Therefore, the baseband processor 1l-20 and the RF processor 1l-10 may be referred to as a transmitter, a receiver, a transceiver, or a communication unit. Furthermore, at least one of the baseband processor 1l-20 and the RF processor 1l-10 may include a plurality of communication modules to support a plurality of different wireless access technologies. In addition, at least one of the baseband processor 1l-20 and the RF processor 1l-10 may include different communication modules to process signals of different frequency bands. For example, the different radio access technologies may include a wireless LAN (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GHz) bands. The UE may transmit/receive signals with the base station by using the baseband processor 1l-20 and the RF processor 1l-10, and the signals may include control information and data.

The storage 1l-30 may store basic programs, application programs, and data, such as configuration information, for operation of the main base station. Particularly, the storage 1l-30 may store information related to a second access node that performs wireless communication by using a second wireless access technology. The storage 1l-30 may provide stored data in response to a request of the controller 1140. The storage 1l-30 may be configured by a storage medium or a combination of storage media, such as a ROM, a RAM, a hard disk, a CD-ROM, and a DVD. In addition, the storage 1l-30 may be configured by multiple memories. According to an embodiment, the storage 1l-30 may store programs for performing the method for altitude event-based measurement result reporting as described above.

The controller 1l-40 may control the overall operation of the UE. For example, the controller 1l-40 may transmit/receive signals through the baseband processor 1l-20 and the RF processor 1l-10. In addition, the controller 1l-40 records data in the storage 1l-30 and reads the data from the storage 1l-30. To this end, the controller 1140 may include at least one processor. For example, the controller 1l-40 may include a communication processor (CP) performing control for communication, and an application processor (AP) controlling a higher layer, such as an application program. In addition, at least one component in the UE may be implemented as a single chip. Furthermore, according to an embodiment of the disclosure, the controller 1l-40 may include a multi-connection processor 1l-42 which performs processing for operation in a multi-connection mode.

According to an embodiment of the disclosure, the controller 1l-40 may control the components of the UE to perform the method for altitude event-based measurement result reporting as described above. That is, the respective components of the UE may be operated to perform the above-described embodiments of the disclosure.

FIG. 1M illustrates a structure of a base station according to an embodiment of the disclosure.

Referring to FIG. 1M, a base station according to an embodiment may include an RF processor 1m-10, a baseband processor 1m-20, a backhaul communication unit 1m-30, a storage 1m-40, and a controller 1m-50. Of course, the example given above is not limiting, and the base station may include a smaller or larger number of components than the components illustrated in FIG. 1M.

The RF processor 1m-10 may perform a function for transmitting and receiving a signal via a wireless channel, such as band conversion and amplification of the signal. That is, the RF processor 1m-10 may upconvert a baseband signal provided from the baseband processor 1m-20, into an RF band signal, and then transmit the RF band signal through an antenna, and downconvert an RF band signal received through the antenna, into a baseband signal. For example, the RF processor 1m-10 may include a transmission filter, a reception filter, an amplifier, a mixer, an oscillator, a DAC, and an ADC. Although only one antenna is illustrated in the drawing, the first access node may include multiple antennas. In addition, the RF processor 1m-10 may include multiple RF chains. Furthermore, the RF processor 1m-10 may perform beamforming. To perform beamforming, the RF processor 1m-10 may adjust the phase and size of each of the signals transmitted or received via multiple antennas or antenna elements. The RF processor may transmit one or more layers to perform a downward MIMO operation.

The baseband processor 1m-20 may perform functions of conversion between baseband signals and bitstrings according to the physical layer specifications of first radio access technology. For example, during data transmission, the baseband processor 1m-20 may generate complex symbols by encoding and modulating a transmitted bitstring. In addition, during data reception, the baseband processor 1m-20 may reconstruct a received bitstring by demodulating and decoding a baseband signal provided from the RF processor 1m-10. For example, when following the OFDM scheme, during data transmission, the baseband processor 1m-10 may encode and modulate a transmitted bitstring to generate complex symbols, may map the complex symbols to subcarriers, and may configure OFDM symbols through an IFFT operation and CP insertion. In addition, during data reception, the baseband processor 1m-20 may divide a baseband signal provided from the RF processor 1m-10 by the units of OFDM symbols, reconstruct signals mapped to subcarriers through FFT calculation and then reconstruct a reception bitstream through demodulation and decoding. The baseband processor 1m-20 and the RF processor 1m-10 may transmit and receive signals as described above. Therefore, the baseband processor 1m-20 and the RF processor 1m-10 may be referred to as a transmitter, a receiver, a transceiver, a communication unit, or a wireless communication unit. The base station may transmit/receive a signal with UEs by using the baseband processor 1m-20 and the RF processor 1m-10, and the signal may include control information and data.

The backhaul communication unit 1m-30 may provide an interface for communicating with other nodes in the network. That is, the backhaul communication unit 1m-30 may convert, into a physical signal, a bitstream transmitted from the main base station to another node, for example, an auxiliary base station, a core network, etc., and may convert a physical signal received from another node, into a bitstream.

The storage 1m-40 may store basic programs, application programs, and data, such as configuration information, for operation of the main base station. Particularly, the storage 1m-40 may store information regarding a bearer allocated to a connected UE, a measurement result reported from the connected UE, and the like. In addition, the storage 1m-40 may store information serving as a reference to determine whether to provide multi-connection to a UE or to suspend the same. In addition, the storage 1m-40 may provide the stored data at the request of the controller 1m-50. The storage 1m-40 may provide the stored data at the request of the controller 1m-50. The storage 1m-40 may be configured by a storage medium or a combination of storage media, such as a ROM, a RAM, a hard disk, a CD-ROM, and a DVD. In addition, the storage 1m-40 may be configured by multiple memories. According to an embodiment, the storage 1m-40 may store programs for performing the method for altitude event-based measurement result reporting as described above.

The controller 1m-50 may control the overall operation of the main base station. For example, the controller 1m-50 may transmit and/or receive a signal via the baseband processor 1m-20 and the RF processor 1m-10, or via the backhaul communication unit 1m-30. In addition, the controller 1m-50 records data in the storage 1m-40 and reads the data from the storage 1m-40. To this end, the controller 1m-50 may include at least one processor. In addition, at least one component in the base station may be implemented as a single chip. In addition, the respective components of the base station may be operated to perform the above-described embodiments of the disclosure. In addition, according to an embodiment of the disclosure, the controller 1m-50 may include a multi-connection processor 1m-52 configured to process processes operating in a multi-connection mode.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet. Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a terminal in a wireless communication system, the method comprising:
transmitting, to a base station, capability information of the terminal;
receiving, from the base station, configuration information for a measurement report; and
transmitting, to the base station, the measurement report based on the configuration information,
wherein the capability information includes information indicating whether the terminal supports omitting measurement reporting associated with serving cells configured as measurement objects, and
wherein, in case that the terminal supports omitting measurement reporting associated with the serving cells configured as the measurement objects, the configuration information includes first information for indicating whether to perform measurement reporting associated with the serving cells.

2. The method of claim 1, wherein the first information indicates to exclude a measurement result associated with the serving cells from the measurement report, or to include a measurement result associated with a special cell (SpCell) or at least one of the serving cells in the measurement report.

3. The method of claim 1, wherein the measurement report further includes a measurement result associated with at least one neighboring cell.

4. The method of claim 1, wherein the terminal is an uncrewed aerial vehicle (UAV),
wherein the measurement report is triggered based on at least one event related to a height of the terminal, and
wherein the measurement report includes at least one of reference signals received power (RSRP) or reference signals received quality (RSRQ) of the serving cells.

5. A method performed by a base station in a wireless communication system, the method comprising:
receiving, from a terminal, capability information of the terminal;
Transmitting, to the terminal, configuration information for a measurement report; and
receiving, from the terminal, the measurement report based on the configuration information,
wherein the capability information includes information indicating whether the terminal supports omitting measurement reporting associated with serving cells configured as measurement objects, and
wherein, in case that the terminal supports omitting measurement reporting associated with the serving cells configured as the measurement objects, the configuration information includes first information for indicating whether to perform measurement reporting associated with the serving cells.

6. The method of claim 5, wherein the first information indicates to exclude a measurement result associated with the serving cells from the measurement report, or to include a measurement result associated with a special cell (SpCell) or at least one of the serving cells in the measurement report.

7. The method of claim 5, wherein the measurement report further includes a measurement result associated with at least one neighboring cell.

8. The method of claim 5, wherein the terminal is an uncrewed aerial vehicle (UAV),
wherein the measurement report is triggered based on at least one event related to a height of the terminal, and
wherein the measurement report includes at least one of reference signals received power (RSRP) or reference signals received quality (RSRQ) of the serving cells.

9. A terminal in a wireless communication system, the terminal comprising:
a transceiver; and
at least one processor connected with the transceiver and configured to:
transmit, to a base station, capability information of the terminal;
receive, from the base station, configuration information for a measurement report; and
transmit, to the base station, the measurement report based on the configuration information,
wherein the capability information includes information indicating whether the terminal supports omitting measurement reporting associated with serving cells configured as measurement objects, and
wherein, in case that the terminal supports omitting measurement reporting associated with the serving cells configured as the measurement objects, the configuration information includes first information for indicating whether to perform measurement reporting associated with the serving cells.

10. The terminal of claim 9, wherein the first information indicates to exclude a measurement result associated with the serving cells from the measurement report, or to include a measurement result associated with a special cell (SpCell) or at least one of the serving cells in the measurement report.

11. The terminal of claim 9, wherein the measurement report further includes a measurement result associated with at least one neighboring cell.

12. The terminal of claim 9, wherein the terminal is an uncrewed aerial vehicle (UAV),
wherein the measurement result is triggered based on at least one event related to a height of the terminal, and
wherein the measurement result includes at least one of reference signals received power (RSRP) or reference signals received quality (RSRQ) of the serving cells.

13. A base station in a wireless communication system, the base station comprising:
a transceiver; and
at least one processor connected with the transceiver and configured to:
receive, from a terminal, capability information of the terminal;
transmit, to a base station, capability information of the terminal; and
receive the measurement report from the terminal, based on the configuration information,
wherein the capability information includes information indicating whether the terminal supports omitting measurement reporting associated with serving cells configured as measurement objects, and
wherein, in case that the terminal supports omitting measurement reporting associated with the serving cells configured as the measurement objects, the configuration information includes first information for indicating whether to perform measurement reporting associated with the serving cells.

14. The base station of claim 13, wherein the first information indicates to exclude a measurement result associated with the serving cells from the measurement report, or to include a measurement result associated with a special cell (SpCell) or at least one of the serving cells in the measurement report.

15. The base station of claim 13, wherein the measurement report further includes a measurement result associated with at least one neighboring cell.
